(19) United States
(12) Patent Application Publication
(10) Pub. No.: US 2023/0287734 A1
(43) Pub. Date: Sep. 14, 2023

(54) VERTICAL SHADE

(71) Applicant: Jesus Estrada, Lakewood, CA (US)

(72) Inventor: Jesus Estrada, Lakewood, CA (US)

(21) Appl. No.: 17/691,001

(22) Filed: Mar. 9, 2022

(51) Int. Cl. E06B 9/262; E06B 9/36

(52) U.S. Cl. CPC E06B 9/262; E06B 9/362; E06B 2009/2625

(57) ABSTRACT

A vertical shade has a head rail suspending a shade. The shade moves horizontally along the head rail which has components for moving the shade. The shade has vertical pleats that divide the fabric into vertical segments. Each pleat extends from the top of the shade to the bottom of the shade. The vertical segments can fold together into a folded position. Each of the hangers is individually attached to each vertical segment and also attached to the head rail. The hanger can be formed as a hole on the rectangular profile. The hanger hole is preferably reinforced using a reinforcing edge strip to prevent fabric from tearing when hung from the head rail. The edge strip is selected from the group of an eyelet, a grommet, a clip, or a ring.

### FIELD OF THE INVENTION

The present invention is in the field of window coverings, such as blinds and shades.

### DISCUSSION OF RELATED ART

Large windows can be covered with vertical blinds. Vertical blinds are made of individual elongated vanes. Each vane is configured to move laterally along a track as well as rotate about its respective longitudinal axis. Therefore, to open vertical blinds, each individual vane must be rotated to be perpendicular to the window. Once the vanes are perpendicular to the window, the vanes can be collapsed onto each other. To cover the window, the vanes must be moved horizontally along the track, then each vane rotated to be parallel to the window. When the vanes are in the parallel orientation, each individual vane overlaps with another so as to block the light from shining through. To coordinate movement of the individual vane, a number of gears must be used to cause uniform rotation of each individual blind.

Furthermore, each individual vane is generally made of a plastic material and held independently within a head rail. Thus, each individual vane can be relatively heavy in light of the small connection relied upon to hold these vanes inside the head rail. As such, these vanes tend to break off easily.

Therefore, there is a need for an alternative window covering that has the advantages of vertical blinds without the disadvantages of the additional components and the ease with which the vanes fall off.

### SUMMARY OF THE INVENTION

The present invention is directed to a vertical shade that has the advantages of a vertical blind without the additional components needed to rotate individual vanes. The vertical shade comprises a single piece shade having the features of vertical blinds. However, instead of individual vanes, the shade is pleated, creating discrete segments, to allow the shade to expand and collapse. The shade is attached to a track within the head rail that ride on carriages that allow for coordinated movement of each segment of the shade.

The fabric pleats are folded with a machine having a heated metal bar that increases the fabric while the rushing folds the fabric in alternative directions creating an accordion like effect. The crease occurs at preset intervals with the fabric folding sequentially in alternating directions. The vertical shade is not limited to vertical blind components; it can also use drapery rod and components.

A vertical shade has a head rail suspending a shade. The shade moves horizontally along the head rail which has components for moving the shade. The shade has a rectangular profile with a top, a bottom opposite the top, a first side extending from the top to the bottom, and a second side opposite the first side and extending from the top to the bottom. The shade has vertical pleats that divide the fabric into vertical segments. Each pleat extends from the top of the shade to the bottom of the shade. The vertical segments can fold together into a folded position. Each of the hangers is individually attached to each vertical segment and also attached to the head rail. The hanger can be formed as a hole on the rectangular profile. The hanger hole is preferably reinforced using a reinforcing edge strip to prevent fabric from tearing when hung from the head rail. The edge strip is selected from the group of an eyelet, a grommet, a clip, or a ring.

The plurality of carriages slide on the track and are each connected the track. The track is formed on the head rail. The carriages are configured to translate along a length of the head rail. Each carriage has a body having a sliding connector. The sliding connector is formed as an opening through the body, and the opening can receive the track. The carriage preferably includes a connector connected to the body of the carriage. The connector makes a connection to the shade to suspend the shade from the head rail. The connector is pivotally mounted to the body of the carriage so as to allow rotation about a longitudinal axis of the connector. The longitudinal axis of the connector is perpendicular to the track. The carriages are attached to each other so that they travel together at a set distance apart. The carriages are attached to each other via slide tabs made of elongated strips of material having two opposing ends, namely a leading end and a lagging end, wherein the leading end is the side of the strip that leads in the direction of expanding the shade.

The carriages have tab connectors fixedly attached to the body, adjacent to the body. The tab connector has a catch, and the tab connector allows the slide tab to slide along the tab connector until it reaches a stop on the leading end of the slide tab engages the catch on the tab connector, such that once the stop engages the catch, the slide tab moves with the carriage.

### BRIEF DESCRIPTION OF THE DRAWINGS

FIG. 1 shows a perspective view of an embodiment of the present invention showing a magnet may be added to the bottom of the vertical shade to keep it open on the bottom.

FIG. 2 shows a close up of a top of a vertical segment of the shade, with an exemplar clip, of which other clip configurations can be used, with perforated or non-perforated fabric and with or without support.

FIG. 3 shows a perspective view of another embodiment of the present invention.

FIG. 4 shows a perspective view of an embodiment of the head rail, of which different types of head rails can be used such as vertical blind head rails, drapery rods or a channel with hooks.

FIG. 5 shows the head rail with the housing removed to show the tracks and carriages.

FIG. 6 is a perspective view of the head rail from one end with the track and carriage partially removed.

FIG. 7 is a close up view of the arrangement of the carriage on the track, the carriage of which can be with or without a magnet.

FIG. 8 is a top plan view of the arrangement of the carriages on the track in the collapsed configuration.

FIG. 9 is a partial side elevation view of the arrangement of the carriages on the track in the expanded configuration.

The following callout list of elements can be a useful guide in referencing the element numbers of the drawings.
21 hanger protrusion
22 hanger loop
23 hanger loop slot
24 right crimp
25 left crimp
26 middle crimp
29 extended middle crimp
100 vertical
102 head rail
104 shade
110 top
112 bottom
114 first side
116 second side
120 pleats
122 a-g vertical segments
124 hanger
130 housing
132 track
134 a-g carriages
136 body
138 sliding connector
140 fixed connector
142 slide tab
142 a-f tabs
144 leading end
146 lagging end
148 stop
150 tab connector
152 catch
160 first end
162 second end
172 elongated housing
174, 176 end caps
178 rails
180 rollers

### DETAILED DESCRIPTION OF THE PREFERRED EMBODIMENT

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

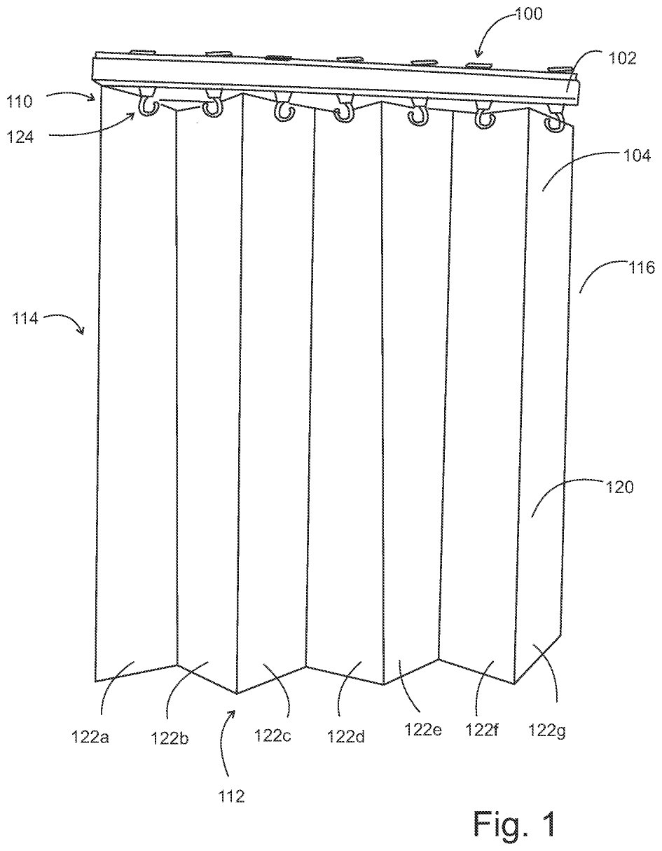

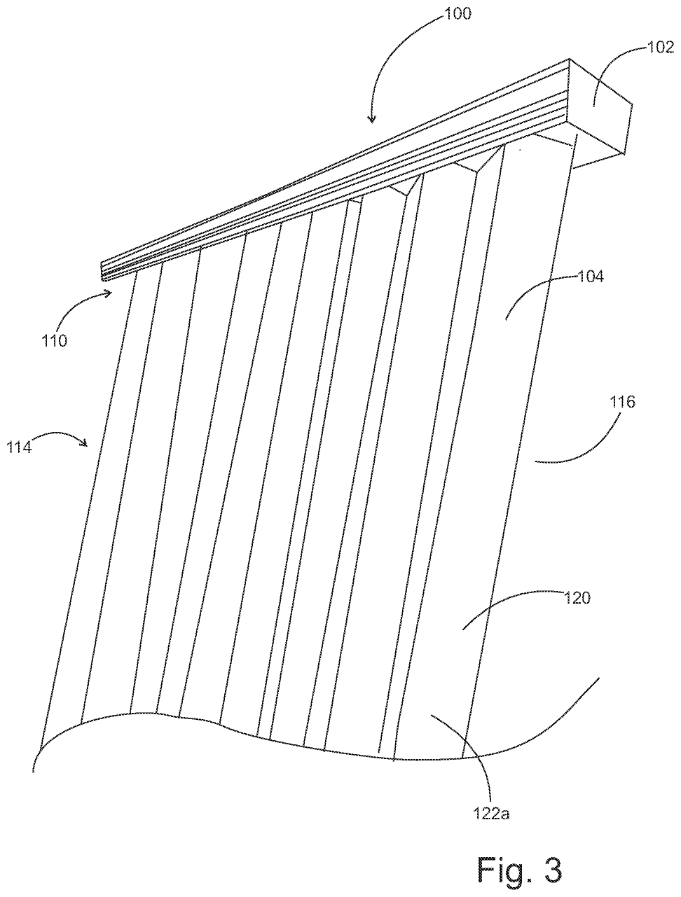

As shown in FIGS. 1-3, the invention of the present application is directed towards a vertical shade 100 comprising a head rail 102 and a shade 104 configured to move horizontally. The head rail 102 houses the components for moving the shade 104 horizontally. The vertical shade 100 is generally used for large windows, such as those on sliding glass doors, French doors, and the like. However, the vertical shade 100 can also be used on smaller and standard windows as on option other than blinds.

The shade 104 can be made of fabric material configured into a rectangular shape having a top 110, a bottom 112 opposite the top 110, a first side 114 extending from the top 110 to the bottom 112, and a second side 116 opposite the first side 114 and extending from the top 110 to the bottom 112. The material used to make the vertical shade is not limited to fabric material. The vertical shade can be made out of other materials such as paper, plastic, wood, aluminum, etc. It can be made of any material attached to some sort of solid frame to create the pleats.

In order to allow for horizontal movement, the shade 104 comprises a plurality of vertical pleats 120 dividing the fabric into vertical segments 122a-g. Each pleat 120 extends from the top 110 of the shade 104 to the bottom 112 of the shade 104. The pleating 120 allows the first side 114 and second side 116 of the shade 104 to move towards each other by allowing the vertical segments 122a-g to fold on top of each other while the overall width of the shade 104 decreases like an accordion.

Each vertical segment 122a-g comprises a hanger 124 to attach to the head rail 102. Each hanger 124 is located at the top of its respective vertical segment 122a-g. The hanger 124 can be a hole, a hook, a clip, a magnet, a clasp, hook-and-loop fastener, and the like. In some embodiments, the hanger 124 can be a hole 124 created directly into the shade 104. The hole can be reinforced using an edge strip to prevent the fabric from tearing while be hung on the head rail 102. By way of example only, the edge strip can be an eyelet, a grommet, a clip, a ring, and the like made from any durable material, such as metal, wood, plastic, rubber, fabrics, and the like.

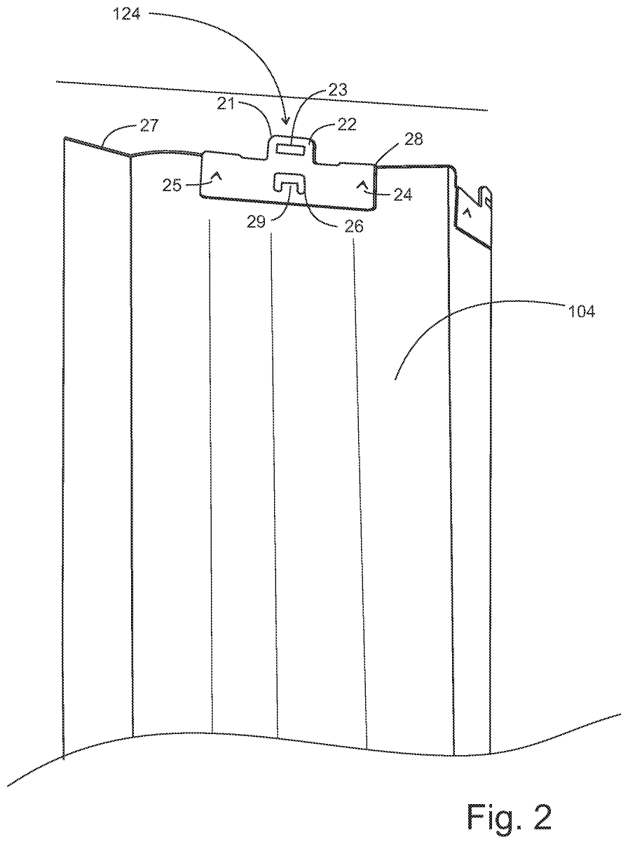

As seen in FIG. 2, the hanger 124 has a hanger protrusion 21 with a hanger loop 22 that forms a hanger loop slot 23. A right crimp 24, a left crimp 25, and a middle crimp 26 secure the hanger 124 to the top edge 27 of the vertical segment 122. The hanger fold 28 folds over the top edge 27 of the vertical segment 122. The right crimp 24, and the left crimp 25, and the middle crimp 26 can be symmetrical on both sides of the hanger 124. The hanger 124 can have a front side and a rear side that are connected together at the top of the hanger 124. The hanger can be folded on a right side and a left side with a middle portion open. The hanger can be secured to the top edge 27 by adhesive liquid glue, adhesive tape, staples or the like. The middle crimp 26 can have a middle crimp opening with an upwardly extending middle crimp tab 29.

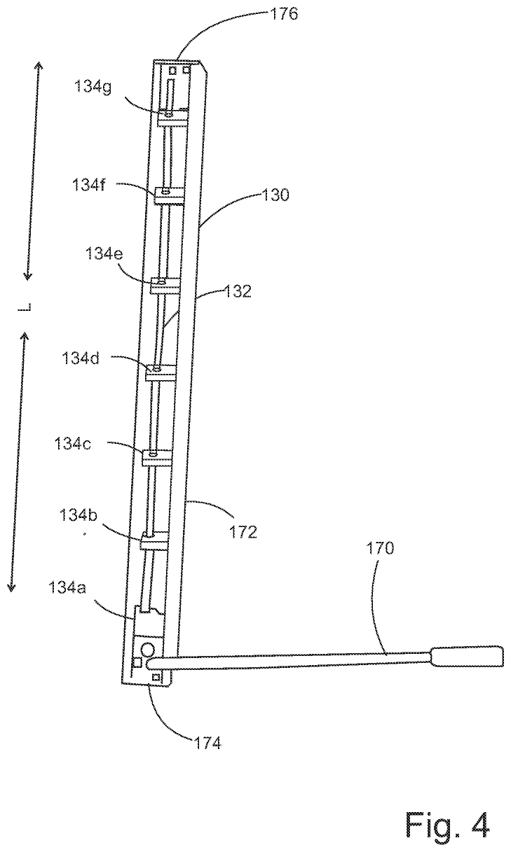

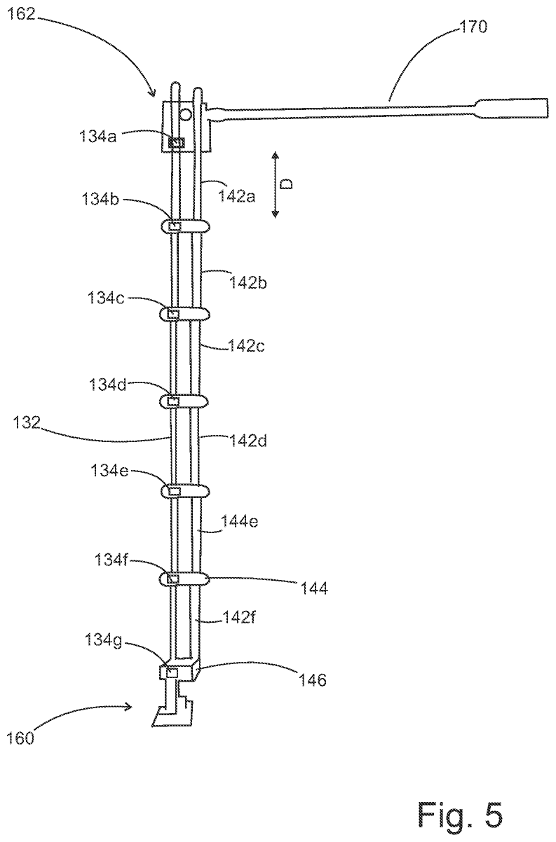

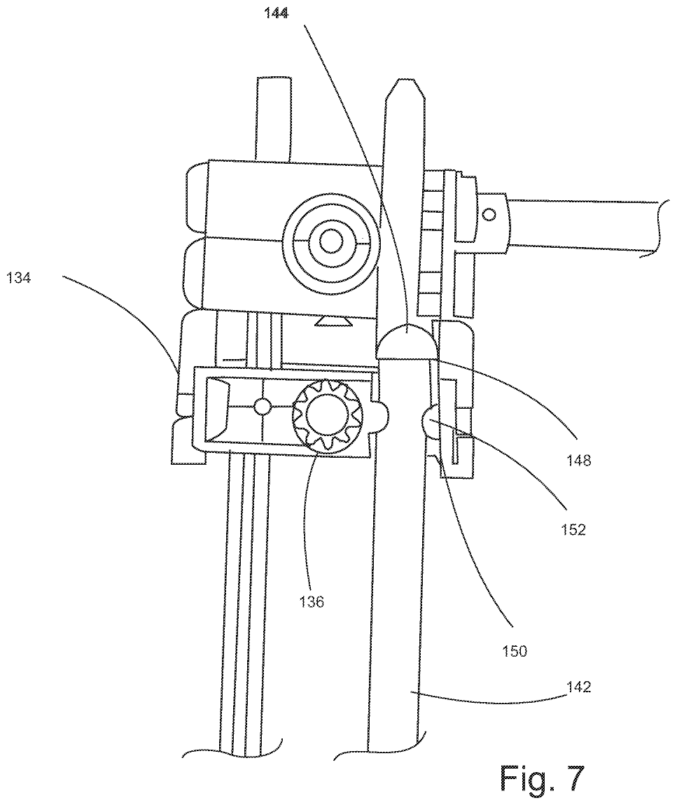

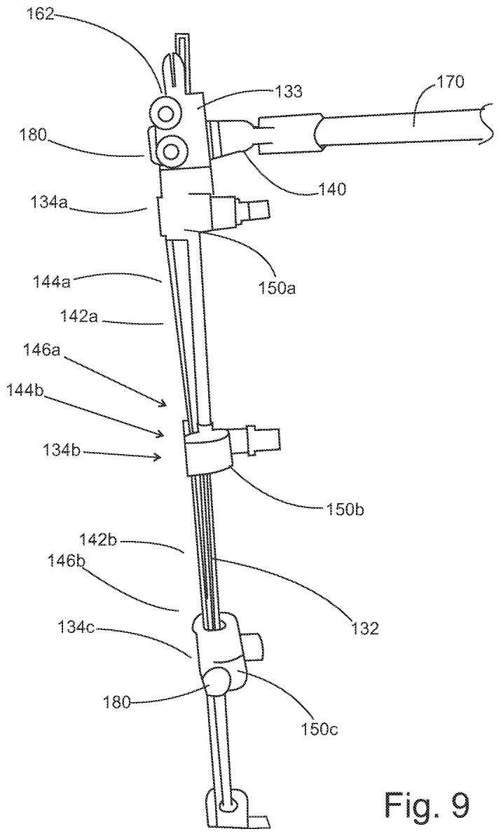

With reference to FIGS. 4-9, the head rail 102 comprises a housing 130 defining a length L, a track 132 attached to the housing 130 and running substantially the length L of the housing 130, and a plurality of carriages 134a-g operatively connected the track 132 in a manner that allows the carriages 134a-g to move along the length of the housing 130. The carriages are not limited to being attached to each other. They can move freely in the head rail without any linkage between them. For example, the tab connector mentioned above.

Each carriage 134 comprises a body 136. The body 136 comprises a sliding connector 138. The sliding connector 138 allows the carriage 134 to attach to the track 132 in a manner that allows the carriage 134 to move along the track 132. In the preferred embodiment, the sliding connector 138 is an opening through the body 136 of the carriage 134. The opening is configured to receive the track 132 with sufficient space to allow the body 136 to move along the track 132. The sliding connector 138 can also be rollers, slide pads, bearings, and the like.

The shade 104 is supported by the head rail 102 via the carriages 134. As such, each carriage 134a-g is configured to hold one of the vertical segments 122a-g of the shade 104. Each carriage 134a-g can comprise a fixed connector 140 connected to the body 136 of the carriage 134 to connect to the shade 104 to the head rail 102. For example, the fixed connector 140 can be a hook, a clip, a magnet, a pin, and the like. One fixed connector 140 can attach to each hole 124 at the top 110 of each vertical segment 122a-g of the shade 104. In the example shown, the fixed connector 140 is a plastic hook. Although the fixed connector 140 is attached to the body 136 in a manner that does not permit translational movement relative to the body 136, the fixed connector 140 can rotate about a longitudinal axis A perpendicular to the track 132.

In some embodiments, the carriages 134a-g can be attached to each other. Thus, with the carriages 134a-g arranged in a series along the track 132, a first carriage 134a can be connected to a second carriage 134b adjacent to the first carriage 134a, the second carriage 134b can be connected to a third carriage 134c adjacent to the second carriage 134b, and so on. The connection between carriages 134a-g can be in a manner that allows the carriages 134a-g to vary the distance D between each other. Therefore, although the first carriage 134a is connected to the second carriage 134b, the first carriage 134a can move along the track 132 relative to the second carriage 134b in a manner that varies the distance D between the first and second carriages 134a, 134b. Each carriage 134a-g can be connected to an adjacent carriage in a similar manner such that the distances D between each adjacent carriage is variable. As a result adjacent carriages can be positioned to touch each other and moved along the track 132 to be separated from each other up to a fixed distance. This type of connection allows a first carriage 134a to move along the track 132 up to a certain distance while the other carriages 134b-g remain stationary. Once the first carriage 134a reaches a certain distance, continual movement of the first carriage 134a in the same direction results in the first carriage 134a pulling on the immediately adjacent second carriage 134b. As the first carriage 134a continues to move along the track 132 pulling on the second carriage 134b, when the second carriage 134b reaches a certain distance, the second carriage 134b pulls on the third carriage 134c in line. This set up allows the vertical segments 122a-g of the shade 104 to expand and collapse against each other.

By way of example only, the carriages 134a-g can be connected to each other with slide tabs 142a-f. The slide tab 142 can be an elongated strip of material having two opposing ends referred to as the leading end 144 and the lagging end 146. The leading end 144 is the side of the strip that leads in the direction of expanding the shade 104 (thereby covering a window). Movement of the carriages 134a-g towards the lagging end 146 collapses the shade 104 (thereby uncovering a window). The leading end 144 of the slide tab 142 comprises a stop 148, and the lagging end of the slide tab 142 can be fixedly connected to one of the carriages 134b-g, except for the first carriage 134a.

Each carriage 134a-g can have a tab connector 150 fixedly attached to the body 136. In the embodiment shown, the tab connector 150 can be laterally adjacent to the body 136. The tab connector 150 comprises a catch 152. The tab connector 150 is configured to allow the slide tab 142 to slide along the tab connector 150 until the stop 148 on the leading end 144 of the slide tab 142 engages the catch 152 on the tab connector 150. Once the stop 148 engages the catch 152, the slide tab 142 moves with the carriage 134. Because the lagging end 146 of a slide tab 142 is connected a trailing carriage 134b-g, when the slide tab 142 moves, the trailing carriage to which the slide tab 142 is connected also moves.

For example, the carriages 134a-g can be aligned at a first end 160 of the track 132 in series with a first carriage 134a in front, and subsequent carriages 134b-g behind in a line. A first slide tab 142a is inserted into the tab connector of the first carriage 134a such that the tab connector 150a of the first carriage 134a is in between the leading end 144 and the lagging end 146 of the first slide tab 142a. This arrangement allows the first carriage 134a to slide along the first slide tab 142a in between its leading and lagging ends 144, 146. The lagging end 146 of the first slide tab 142a is fixed to the tab connector 150b of the second carriage 134b in line. The first carriage 134a is advanced toward the second end 162 of the track 132 while the first tab 142a and the subsequent carriages remain stationary. One the catch 152 on the first tab connector 150a engages the stop 148 on the leading end 144 of the first slide tab 142a, the first slide tab 142a then begins to move with the first carriage 134a. Because the lagging end 146 of the first slide tab 142a is fixed to the second carriage 134b, the second carriage 134b moves with the first carriage 134a and the first slide tab 142a at this point.

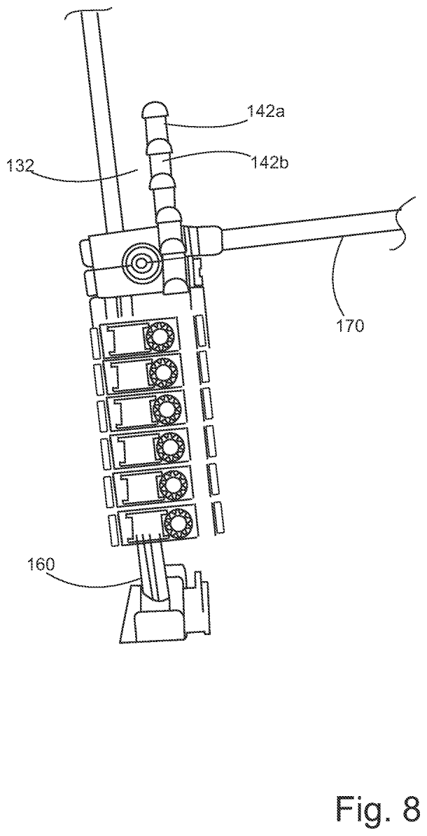

The second carriage 134b is similarly arranged with the third carriage 134c in line. Specifically, a second slide tab 142b is inserted in the tab connector 150b of the second carriage 134b such that the second carriage 134b can slide along the second slide tab 142b in between its leading and lagging ends 144b, 146b. The lagging end 146b of the second slide tab 142b is fixed to a third carriage 134c. Due to the length of the slide tab, a substantial portion of the second slide tab 142b may overlap on top of portions of the first slide tab 142a when in the collapsed configuration as shown in FIG. 8. As the first carriage 134a advances forward and eventually catches the stop 148 on the first slide tab 142a, the first slide tab 142a advances forward along with the second carriage 134b. The first slide tab 142a and the second carriage 134b then slide along the second slide tab 142b until the catch 152 of the second tab connector 150b engages the stop 148 of the second slide tab 142b. At this point, the lagging end 146a of the first slide tab 142a overlaps with the leading end 144b of the second slide tab 142b where the tab connector 150b of the second carriage 134b engages the leading end 144b of the second slide tab 142b. Continual movement of the first carriage 134a towards the second end 162 of the track 132 causes the first slide tab 142a to follow, which causes the second carriage 134b to follow, which eventually causes the second slide tab 142b to follow. The lagging end 146b of the second slide tab 142b is fixed to the third carriage 134c in line, and advancement of the second slide tab 142b causes the third carriage 134c to follow. This setup continues with subsequent carriages and slide tabs.

Because each carriage 134a-g is connected to a vertical segment 122a-g of the shade 104, each vertical segment 122a-g of the shade 104 follows its respective carriage 13 4a-g, and spreads apart from each other causing the shade 104 to expand into its open configuration to cover a window. Moving in the reverse direction causes the vertical segments 122a-g to move towards each other, thereby, collapsing the shade 104 into its closed configuration to uncover the window.

Movement of the first carriage 134a can be facilitated by the use of a wand 170. The wand 170 only needs to be attached to the first carriage 134a because the remaining carnages 134b-g follow the movement of the first carriage 134a. The total number of carriages 132a-g required depends on the size of the shade. As such, the number of carriages shown here are not limiting. In some embodiments, the wand 170 can be attached to a lead carriage 133 that is in turn attached to the first carriage 134a. The lead carriage is similar to the first carriage 134 except that the fixed connector 140 connects to the wand 170 instead of the shade 104. The vertical shade is not limited to being operated with the wand. It can also be operated without a wand or with a remote control.

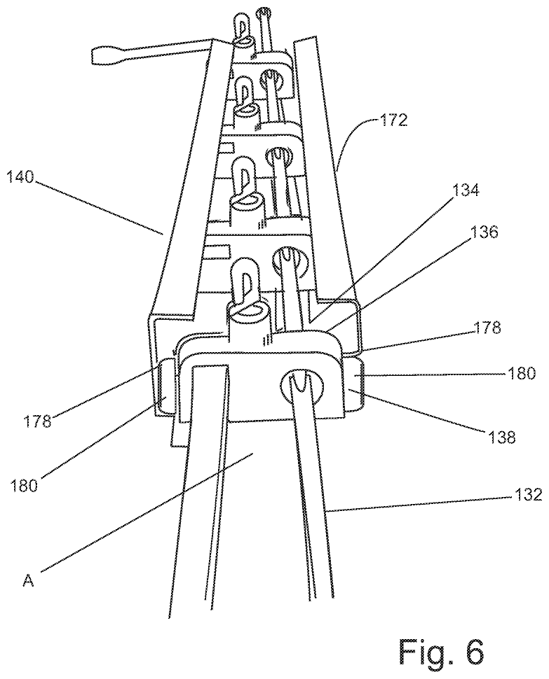

To facilitate movement of the carriages 134a-g and add aesthetics to the vertical shade 100, the carriages 134a-g and track 132 are placed inside the elongated housing 172 of the head rail 102 as shown in FIG. 4. In the preferred embodiment, the housing 172 comprises end caps 174, 176 that attach to the ends of the housing 172. Each end of the track 132 can attach to these end caps 174, 176 to be suspended within the housing 172. The housing 172 can further comprise rails 178 on opposite sides as shown in FIG. 6. The carriages 134 can comprise rollers 180 that ride along the rails 178 to facilitate movement of the carriages 134 along the track 132.

There are many options of fabric for the shade 104 depending on the features sought. For example, fabric for the shade 104 can be selected based on different levels of light filtering, heat control, different levels of air filtering, and/or decorative colors, textures, and patterns.

Unlike vertical blinds, the shade 104 is a single piece of fabric material with pleating 120 that allows the shade 104 to expand and collapse. The advantage of a single piece shade 104 over the vertical bind is in the simplicity of the sliding mechanism. The invention of the present application does not require the additional gears required for vertical blinds to cause each individual vane to rotate about its longitudinal axis.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

1. A vertical shade comprising:
a. a head rail;
b. a shade, wherein the shade is configured to move horizontally, wherein the head rail houses components for moving the shade horizontally;
c. a rectangular profile, wherein the shade forms the rectangular profile having a top, a bottom opposite the top, a first side extending from the top to the bottom, and a second side opposite the first side and extending from the top to the bottom;
d. a plurality of vertical pleats, wherein the plurality of for vertical pleats divide the fabric into vertical segments, wherein each pleat extends from the top of the shade to the bottom of the shade, wherein the vertical segments can fold together into a folded position;
e. a plurality of hangers, wherein each hanger is individually attached to each vertical segment and also attached to the head rail.

2. The vertical shade of claim 1, wherein the hanger is formed as a hole on the rectangular profile, wherein the hole is reinforced using a reinforcing edge strip to prevent fabric from tearing hung on the head rail.

3. The vertical shade of claim 1, the edge strip is selected from the group of an eyelet, a grommet, a clip, or a ring.

4. The vertical shade of claim 1, further including a plurality of carriages and a track, wherein the plurality of carriages are each connected the track, wherein the track is formed on the head rail, wherein the carriages are configured to translate along a length of the head rail.

5. The vertical shade of claim 4, wherein each carriage of the plurality of carriages further comprises a body having a sliding connector, wherein the sliding connector is formed as an opening through the body, wherein the opening receives the track.

6. The vertical shade of claim 4, wherein each carriage of the plurality of carriages has a connector connected to the body of the carriage, wherein the connector makes a connection to the shade to suspend the shade from the head rail.

7. The vertical shade of claim 4, wherein the fixed connector is a hook, wherein the connector is pivotally mounted to the body of the carriage so as to allow rotation about a longitudinal axis of the connector, wherein the longitudinal axis of the connector is perpendicular to the track.

8. The vertical shade of claim 4, wherein the carriages are attached to each other so that they travel together at a set distance apart.

9. The vertical shade of claim 4, wherein the carriages are attached to each other via slide tabs made of elongated strips of material having two opposing ends, namely a leading end and a lagging end, wherein the leading end is the side of the strip that leads in the direction of expanding the shade.

10. The vertical shade of claim 9, wherein the carriages have tab connectors fixedly attached to the body, adjacent to the body, wherein the tab connector has a catch, wherein the tab connector allows the slide tab to slide along the tab connector until a stop on the leading end of the slide tab engages the catch on the tab connector, such that once the stop engages the catch, the slide tab moves with the carriage.
